(19) United States
(12) Patent Application Publication
(10) Pub. No.: US 2017/0041101 A1
(43) Pub. Date: Feb. 9, 2017

(54) RE-TRANSMISSION CONTROL METHOD AND COMMUNICATION DEVICE

(71) Applicant: HON HAI PRECISION INDUSTRY CO., LTD., New Taipei (TW)

(72) Inventors: DA-CHENG WU, New Taipei (TW); Chia-Hao Liu, New Taipei (TW)

(21) Appl. No.: 14/819,588

(22) Filed: Aug. 6, 2015

(51) Int. Cl. H04L 1/08; H04L 1/18

(52) U.S. Cl. CPC H04L 1/08; H04L 1/1896

(57) ABSTRACT

A re-transmission method is provided. The method includes: generating, at a transmitting party, a packet; adding, at the transmitting party, parity check bits to the packet to form a new packet; transmitting, at the transmitting party, the new packet to a receiving party; determining, at the transmitting party, whether an ARQ feedback is received, wherein the ARQ feedback indicates which half part of the packet is found erroneous at the receiving party if the packet is found erroneous at the receiving party; determining, at the transmitting party, which half part of the packet is found erroneous based on the ARQ feedback if the ARQ feedback is received; and re-transmitting, at the transmitting party, the half part of the packet which is found erroneous at the receiving party.

### FIELD

The subject matter herein generally relates to an apparatus and a method for Automatic Repeat reQuest (ARQ) in a communication system, and particularly to a re-transmission control method and a communication device using the same.

### BACKGROUND

Communication systems, including wired communication system and wireless communication system, are subject to data error according to the channel noise or interference. To raise transmission reliability, the communication systems generally control and recover the data error using an Automatic Repeat reQuest (ARQ) scheme.

Using the ARQ scheme, a receiving party informs a transmitting party of reception success or failure of a packet received from the transmitting party. For example, when the packet received from the transmitting party has no error, the receiving party sends ACKnowledge (ACK) information to the transmitting party. When the packet received from the transmitting party is erroneous, the receiving party sends Negative ACK (NACK) information to the transmitting party. The ACK information and the NACK information are referred to as ARQ feedback. Upon the transmitting party receives the NACK information, the transmitting party re-transmits the packet to the receiving party.

### BRIEF DESCRIPTION OF THE DRAWINGS

Implementations of the present technology will now be described, by way of example only, with reference to the attached figures.

FIG. 1 is a block diagram of an exemplary embodiment of a communication system.

FIG. 2 is a flowchart of an exemplary embodiment of a re-transmission control method performed by a transmitting party.

FIG. 3 is a diagrammatic view of an exemplary embodiment of packet.

FIG. 4 is a diagrammatic view of an exemplary embodiment of a re-transmission process.

FIG. 5 is a diagrammatic view of another exemplary embodiment of a re-transmission process.

FIG. 6 is a flow chart of an exemplary embodiment of a re-transmission control method performed by a receiving party.

FIG. 7 is a diagrammatic view of an exemplary embodiment of a re-transmission process.

FIG. 8 is a diagrammatic view of another exemplary embodiment of a re-transmission process.

FIG. 9 is a diagrammatic view of another exemplary embodiment of a re-transmission process.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

Communication systems, for example, wired communication system or wireless communication system are widely deployed to provide various types of communication content such as voice, data, and so on. These communication systems may be multiple-access systems capable of supporting communication with multiple users by sharing the available system resources (e.g., bandwidth and transmit power). Examples of such multiple-access systems can include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

In such communication systems, communication content can be formed in a plurality of packets which are transmitted between a transmitting party and a receiving party. A packet typically is presented in binary form, which is arranged in a specific form for data transfer. Normally, a packet comprises a heading, which contains, e.g. control data, such as synchronization bits, a target address, the sender's address, the length of the packet, payload, which contains the data to be transferred and a tail part, which normally contains data intended for the identification and correction of errors.

In the communication system, at least one transmitting party and at least one receiving party communicates with each other so as to share communication content.

A transmitting party and a receiving party can include all of transmitting and receiving nodes constituting the communication system, respectively, for example, a base station controller, a Base Station (BS), a mobile station, a relay station, and the like. Mobile stations may also be known as subscriber stations, terminals, nodes, and similar terms. Examples of mobile stations include mobile phones, personal digital assistants, personal entertainment devices, laptop computers, and tablet computers.

To raise transmission reliability, An Automatic Repeat reQuest (ARQ) process can be used. During the ARQ process, the receiving party can inform the transmitting party of transmitting success or failure by ARQ feedback. ARQ feedback can include a character or a character string configured to indicate whether the transmission has succeeded or failed. Typically, the transmitting party who does not receive an acknowledgement within a predefined time, or gets an acknowledgement indicating that the transmission has failed, may re-transmit the packet.

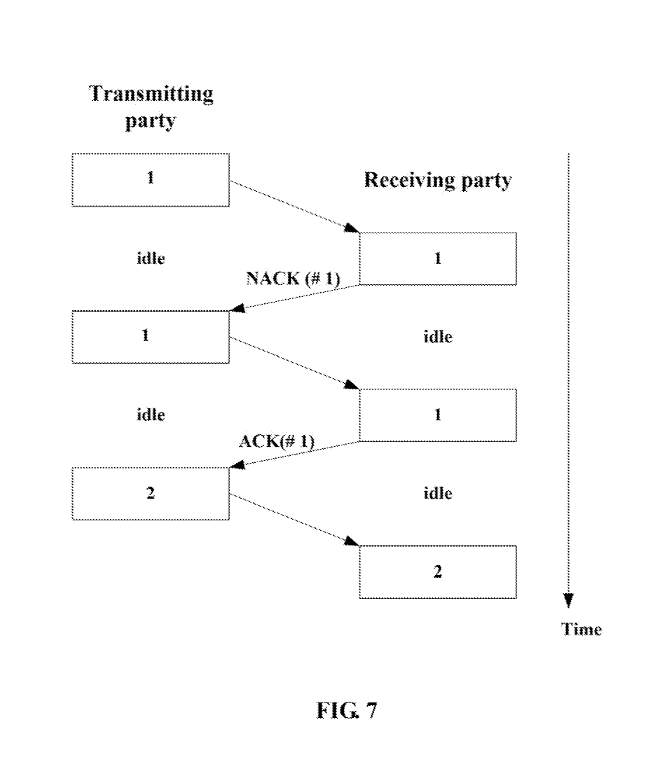

Typically, the packet can be re-transmitted through at least one of the following process: stop-and wait, go-back N ARQ, and select-repeat ARQ. An exemplary embodiment of a stop-and-wait method is illustrated in FIG. 7. During the stop-and-wait process, firstly, the transmitting party transmits a first packet to the receiving party. The receiving party returns ARQ feedback to the transmitting party upon receiving the first packet. If the first packet is erroneous, the transmitting party retransmits the first packet. If the first packet is errorless, the transmitting party begins to transmit a second packet. During the transmission of packet or ARQ feedback, the transmitting party or the receiving party stays idle.

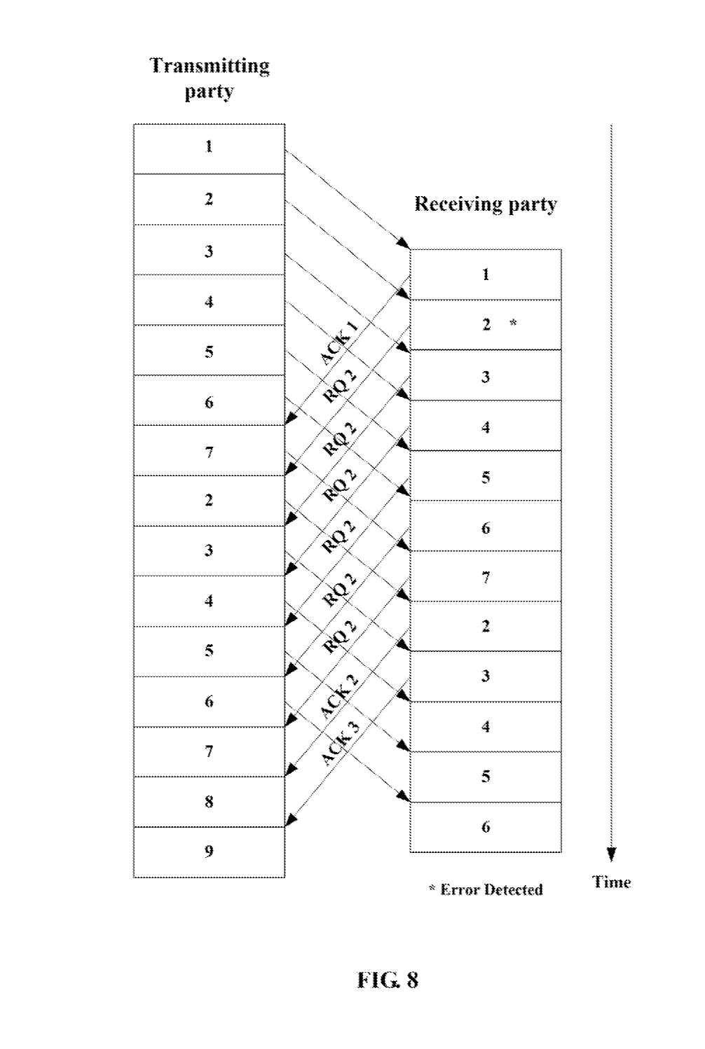

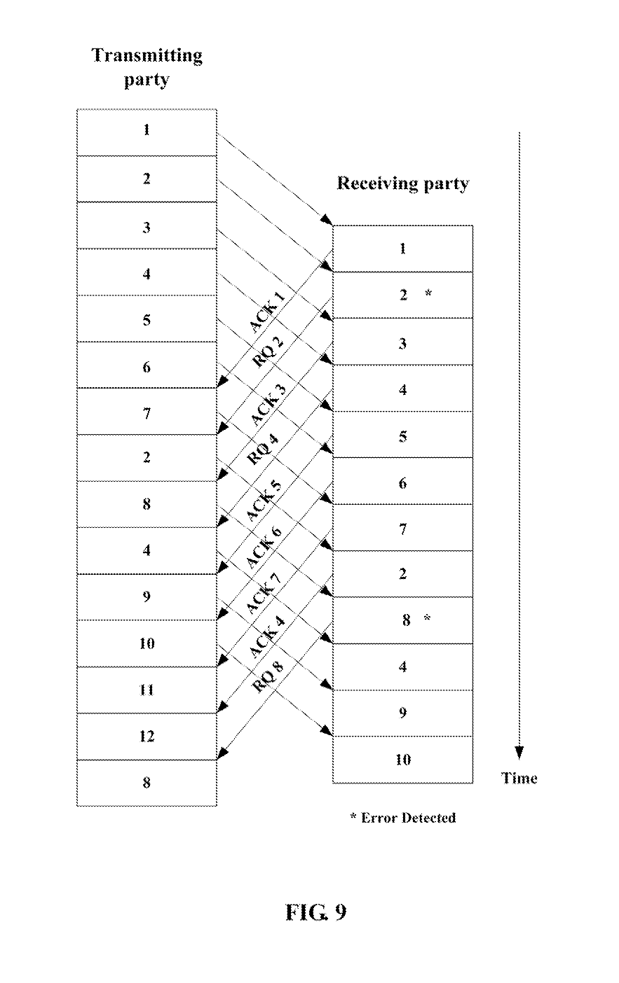

In order to improve transmission efficiency, the go-back N ARQ and the select-repeat ARQ are developed. An exemplary embodiment of the go-back N ARQ is illustrated in FIG. 8. During go-back N ARQ process, the transmitting party transmits packets in sequence all the time until received ARQ feedback indicating an erroneous packet from the receiving party and retransmits the packet which is incorrectly received by the receiving party and all the packets successive to the erroneous packet. An exemplary embodiment of the select-repeat ARQ is illustrated in FIG. 9. During the go-back N ARQ process, the transmitting party transmits packets in sequence all the time until receiving ARQ feedback indicating an erroneous packet from the receiving party and retransmits the packet.

In the above mentioned methods, the whole original packet is re-transmitted when the received packet is erroneous. However, sometimes, the erroneous packet has an error only in part of the packet, for example, a first half part or a second half part.

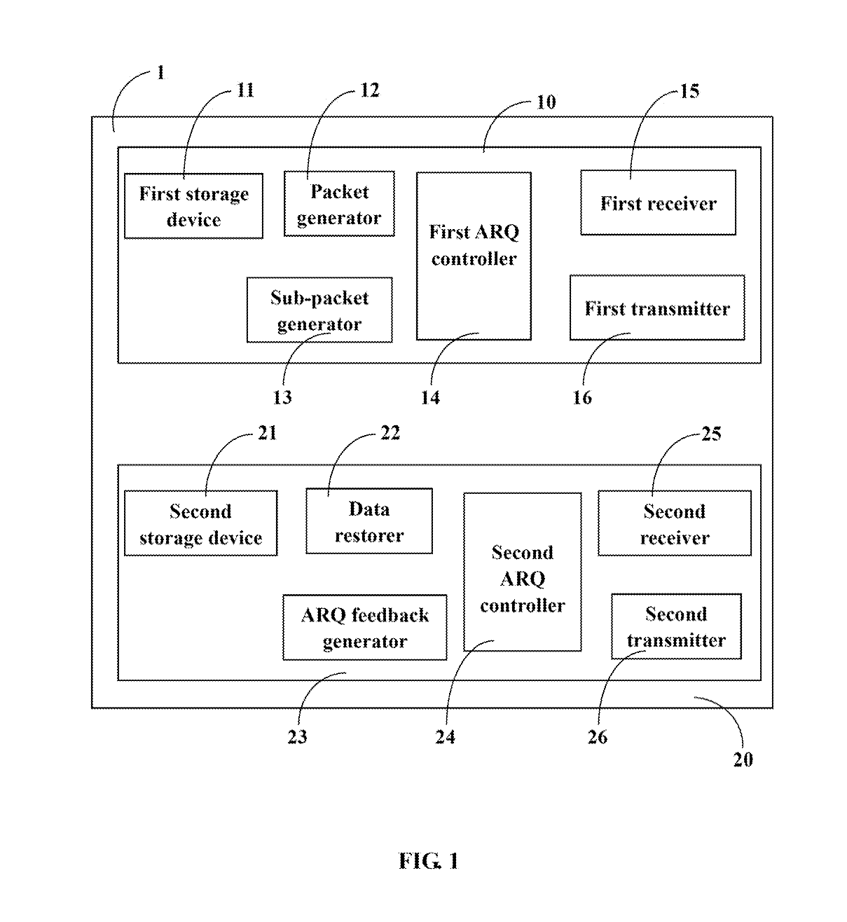

FIG. 1 illustrates an exemplary embodiment of a communication system 1. The communication system 1 can include at least one transmitting party 10 and at least one receiving party 20. The communication system can include any type of communication systems, for example, wire communication system, radio, 802.11 standard WiFi™, cellular, satellite, and television broadcasting. The transmitting party 10 or the receiving party 20 can include all of transmitting and receiving nodes constituting the communication system mentioned above.

The transmitting party 10 can include, but is not limited to, a first storage device 11, a packet generator 12, a sub-packet generator 13, a first ARQ controller 14, a first receiver 15 and a first transmitter 16.

The first storage device 11 can be configured to store data generated in upper application programs. The data can be stored in a form of a data queue.

The packet generator 12 can be configured to package data to form a packet suitable for transmitting. An exemplary embodiment of a packet can include, but is not limited to, a head part, a payload, and a tail part. The head part can contain, for example control data, such as synchronization bits, a target address, the sender's address, and the length of the packet. The payload can contain the data to be transferred. The tail part generally can contain data intended for the identification and correction of errors. Each packet can have a unique Serial Number (SN).

The sub-packet generator 13 can be configured to packet a half part of a parent packet which is found erroneous in the receiving party to be a sub-packet suitable for transmitting. The sub-packet can in a similar format with the packet. The sub-packet can include at least one bit indicating a SN of the parent packet.

The first ARQ controller 14 can be configured to control transmission of a packet or a sub-packet. The first ARQ controller 14 further can be configured to add Parity Check (PC) bits to each packet. The PC bits can include a first bit representing a number of “1” in a first half part of the packet, and a second bit representing a number of “1” in a second half part of the packet. For example, if the number of “1” in the first half part of the packet is even, the value of the corresponding PC bit can be “0” or “1”; if the number of “1” in the first half part of the packet is odd, the value of the corresponding PC bit can be “1” or “0”.

The first receiver 15 can be configured to receive ARQ feedback from the receiving party 20. In the exemplary embodiment, the first receiver 15 can be a Radio Frequency (RF) receiver.

The first transmitter 16 can be configured to transmit the packet or sub-packet to the receiving party 20. In the exemplary embodiment, the first transmitter can be a RF transmitter.

The receiving party 20 can include, but is not limited to, a second storage device 21, a packet restorer 22, an ARQ feedback generator 23, a second ARQ controller 24, a second receiver 25, and a second transmitter 26.

The second storage device 21 can be configured to store data received at the receiving party 20. The data can be stored in a form of a data queue.

The packet restorer 22 can be configured to regroup two or more sub-packets to restore the packet transmitted from the transmitting party 10.

The ARQ feedback generator 23 can be configured to generate an ARQ feedback in response to a received ARQ packet or sub-packet.

The second ARQ controller 24 can be configured to checks for errors in the ARQ packet or the ARQ sub-packets. The second ARQ controller 24 further can be configured to checks for an ARQ feedback time and controls the ARQ feedback generator 23 to generate the ARQ feedback when the ARQ feedback is ready for processing.

The second receiver 25 can be configured to receive ARQ packets or sub-packets from the transmitting party 10. In the exemplary embodiment, the second receiver 25 can be a RF receiver.

The second transmitter 26 can be configured to transmit ARQ feedback to the transmitting party 10. In the exemplary embodiment, the first transmitter can be a RF transmitter.

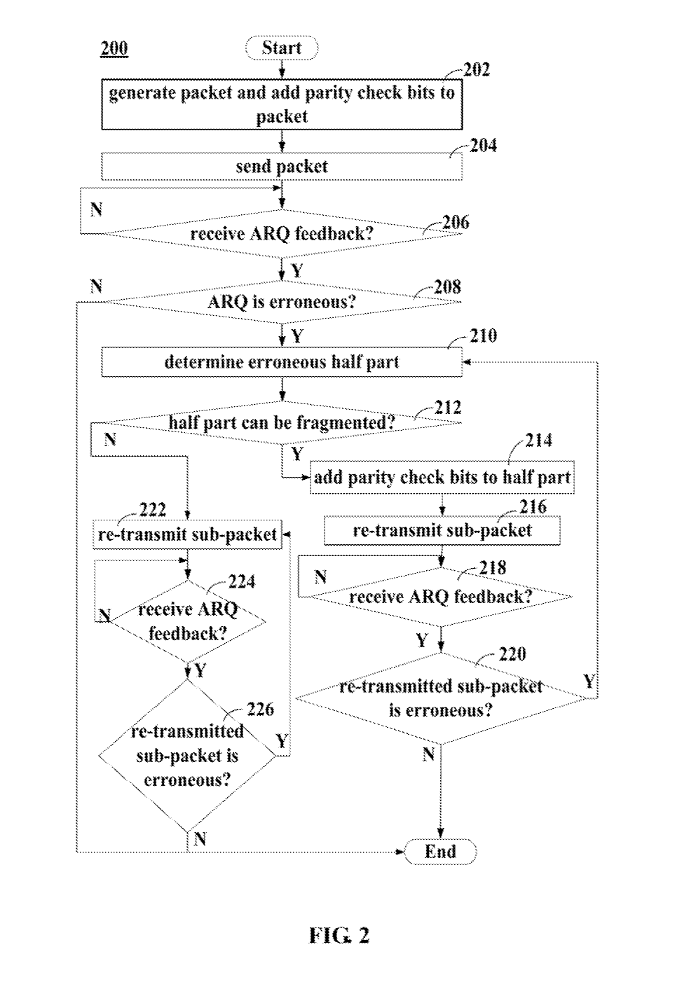

FIG. 2 illustrates a flowchart of an exemplary embodiment of a re-transmission control method 200 performed by a transmitting party. The example method 100 is provided by way of example, as there are a variety of ways to carry out the method. The method 200 described below can be carried out using the configurations illustrated in FIG. 1, for example, and various elements of the figure is referenced in explaining example method 200. Each block shown in FIG. 2 represents one or more processes, methods or subroutines, carried out in the exemplary method 100. Furthermore, the illustrated order of blocks is by example only and the order of the blocks can change according to the present disclosure. Additional blocks may be added or fewer blocks may be utilized, without departing from this disclosure. The exemplary method 200 can be executed by a transmitting party, and can begin at block 202.

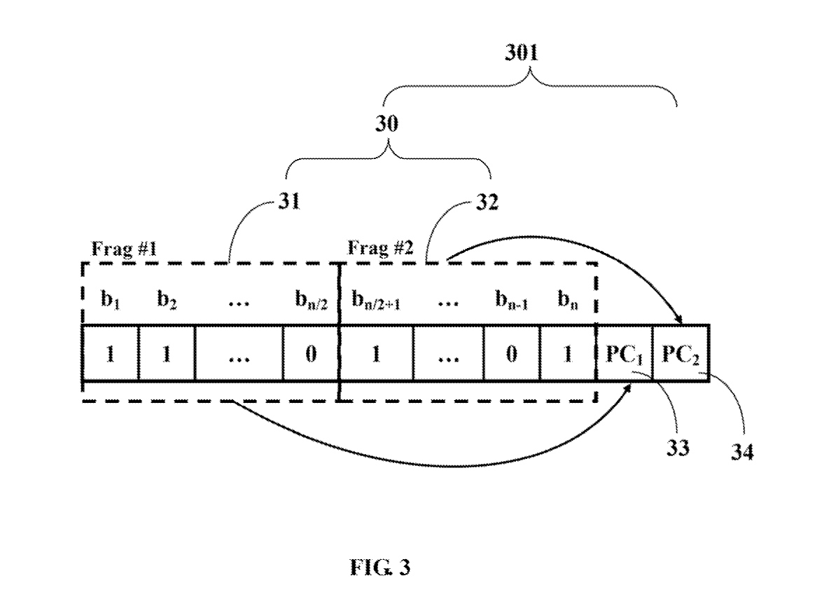

At block 202, the transmitting party generates an original packet and adds parity check bits to the original packet to form a new packet. The original packet can include a heading, which contains, for example control data, such as synchronization bits, a target address, the sender's address, the length of the packet, payload, which contains the data to be transferred and a tail part, which normally contains data intended for the identification and correction of errors. In the exemplary embodiment, only payload data of a packet is shown, for example, an original packet 30 only having payload data illustrated in FIG. 3. In at least one exemplary embodiment, the original packet 30 can include a head part and a tail part. However, for ease of description, only payload data is shown in the original packet 30. The original packet 30 can be divided into two half parts 31, 32. The transmitting party can add two parity check bits 33 and 34 to the original packet 30 to form a new packet 301. The first parity check bit 33 is corresponding to the first half part 31, and the second parity check bit 34 is corresponding to the second half part 32.

At block 204, the transmitting party transmits the new packet 301 to a receiving party.

At block 206, the transmitting party determines whether an ARQ feedback of the new packet 301 is received. If an ARQ feedback of the new packet 301 is received, the process goes to block 208, otherwise, the process goes back to block 206. In at least one embodiment, if the transmitting party does not receive an ARQ feedback of the new packet 301 within a predefined time, the transmitting party will retransmit the new packet 301.

At block 208, the transmitting party determines whether the new packet 301 received by the receiving party is erroneous based on the ARQ feedback of the new packet 301. In the exemplary embodiment, the ARQ feedback of the new packet 301 can include at least one bit indicating whether the new packet 301 is received successfully, and at least one bit indicating identification of the new packet 301, for example, “#1”. If the new packet 301 received by the receiving party is erroneous, the process goes to block 214, otherwise, the process goes to an end.

At block 210, the transmitting party determines which one of the two half parts is erroneous based on the parity check bits. In the exemplary embodiment, each parity check bit indicating a number of “1” of the corresponding half part of the packet 30. For example, if the number of “1” is even, the parity check bit can be “0” or “1”; if the number of “1” is odd, the parity check bit can be “1” or “0”. If the number of “1” in an half part of the received packet is not corresponding to the corresponding check parity bit, the half part is determined to be erroneous, otherwise, the half part is determined to be errorless.

At block 212, the transmitting party determines whether the half part can be further fragmented into two half parts. In the exemplary embodiment, the minimum length of a half part can be 64 bytes. In at least one exemplary embodiment, the minimum length of a half part can be any suitable length as desired, for example, 128 bytes. If the length of the half part is equal to or less than the minimum length of a half part, it is determined that the half part cannot be fragmented, otherwise, the half part can be fragmented. If the packet can be fragmented, the process goes to block 214, otherwise the process goes to block 222.

At block 214, the transmitting party packages the half part which is found erroneous at the receiving party to be a sub-packet and then adds parity check bits to the sub-packet to form a new sub-packet.

At block 216, the transmitting party re-transmits the new sub-packet.

At block 218, the transmitting party determines whether an ARQ feedback of the new sub-packet is received. If an ARQ feedback of the new sub-packet is received, the process goes to block 220, otherwise, the process goes back to block 218. In at least one embodiment, if the transmitting party does not receive an ARQ feedback of the new sub-packet within a predefined time, the transmitting party will retransmit the new sub-packet.

At block 220, the transmitting party determines whether the new sub-packet is found erroneous at the receiving party based on the ARQ feedback of the new sub-packet. If the new sub-packet is found erroneous, the process goes back to block 210 to determine which half part of the sub-packet is erroneous; otherwise, the process goes to the end.

At block 222, the transmitting part packages the half part which is found erroneous at the receiving party to be a sub-packet, and re-transmit the sub-packet to the receiving party.

At block 224, the transmitting party determines whether an ARQ feedback of the sub-packet is received. If an ARQ feedback of the sub-packet is received, the process goes to block 226, otherwise, the process goes back to block 224. In at least one embodiment, if the transmitting party does not receive an ARQ feedback of the sub-packet within a predefined time, the transmitting party will re-transmit the sub-packet.

At block 226, the transmitting party determines whether the sub-packet is found erroneous at the receiving party based on the ARQ feedback of the sub-packet. If the sub-packet is found erroneous at the receiving party, the process goes to block 222 to re-transmit the sub-packet; otherwise the process goes to the end.

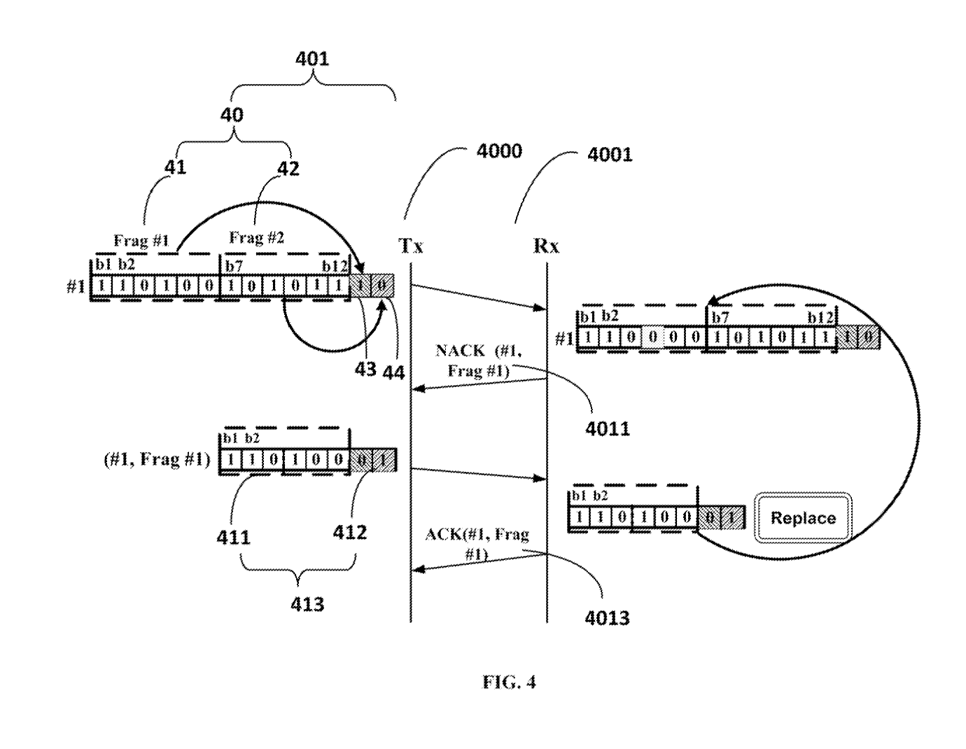

As illustrated in FIG. 4, an original packet 40 having a serial number “#1” includes a first half part 41 and a second half part 42. Two parity check bits 43 and 44 are added to the original packet 40 to form a new packet 401. The number of “1” in the first half part 41 is three, therefore the first parity check bit is assigned to be “1”; while the number of “1” in the second half part 42 is four, therefore the second parity check bit is assigned to be “0”. The new packet 401 is transmitted from the transmitting party 4000 to the receiving party 4001. If the packet 401 is found erroneous at the receiving party 4001, the receiving party can transmit an ARQ feedback 4011, for example, NACK (#1, Frag#1) 4011 indicating the first half part 41 of the packet 40 has an error, to the transmitting party 4000. The transmitting party 4000 determines that the first half part 41 can be further fragmented, therefore packages the first half part 41 to a sub-packet 411 and add parity check bits 412 to the sub-packet 411 to form a new sub-packet 413. If the new sub-packet 413 is found errorless at the receiving party 4001, the receiving party 4001 will transmit an ARQ feedback, for example, ACK (#1, Frag#1) 4013. The errorless sub-packet 411 can be used to replace the erroneous part of the packet 401 so as to restore the packet 401.

Additionally, if the sub-packet 413 is still found erroneous at the receiving party 4001, the receiving party 4000 will determine that which half part of the sub-packet is erroneous and determine whether the erroneous half part of the sub-packet can be further fragmented. If the erroneous half part of the sub-packet can be further fragmented, the transmitting party 4000 will packet the half part of the sub-packet to be a sub-packet and add parity check bits to form a new sub-packet to be transmitted to the receiving party 4001. If the erroneous half part of the sub-packet cannot be further fragmented, the transmitting party 4000 will not add parity check bits to the sub-packet corresponding to the half part of the sub-packet.

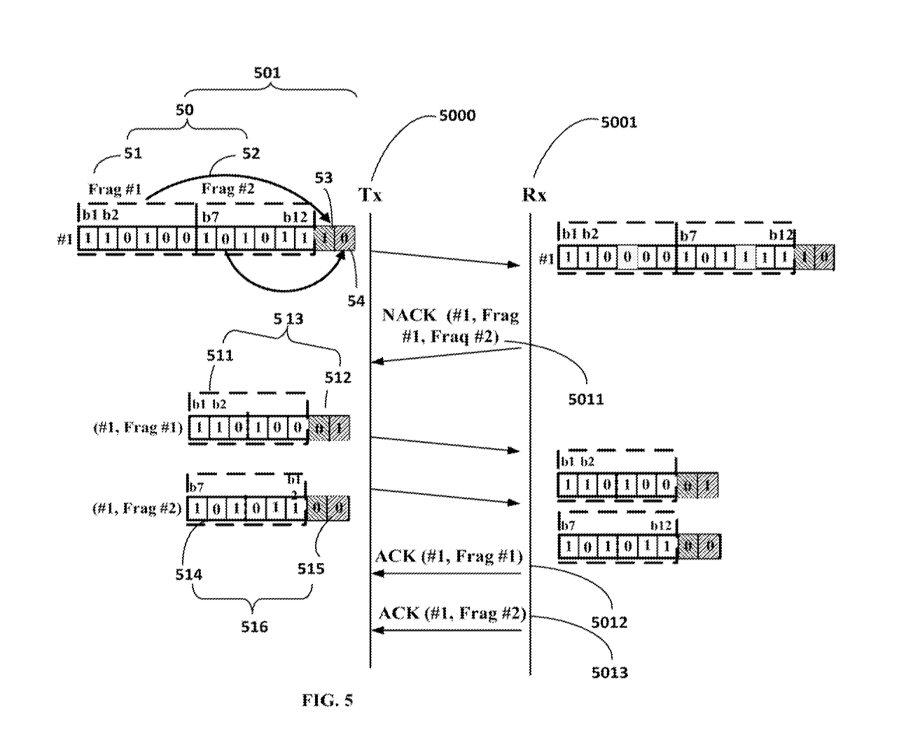

If two half parts of the packet are found erroneous at the receiving party, the transmitting party will re-transmit two sub-packets corresponding to the two half parts. Referring to FIG. 5, an original packet 50 having a serial number “#1” includes a first half part 51 and a second half part 52. Two parity check bits 53 and 54 are added to the original packet 50 to form a new packet 501. The number of “1” in the first half part 51 is three, therefore the first parity check bit 53 is assigned to be “1”; while the number of “1” in the second half part 52 is four, therefore the second parity check bit 54 is assigned to be “0”. The new packet 501 is transmitted from the transmitting party 5000 to the receiving party 5001. If the packet 501 is found erroneous at the receiving party 5001, the receiving party can transmit an ARQ feedback, for example, NACK (#1, Frag#1, Frag#2) 5011 indicating both the first half part 51 and the second half part 52 of the packet 50 has an error, to the transmitting party 5000. The transmitting party 5000 determines that the first half part 51 and the second half part 52 can be further fragmented, therefore packages the first half part 51 to a first sub-packet 511 and the second half part 52 to a second sub-packet 512. Then the transmitting party 5000 adds parity check bits 512 to the first sub-packet 511 to form a first new sub-packet 513, and adds parity check bits 515 to the second sub-packet 514 to form a second new sub-packet 516. If the first and second new sub-packets 513, 516 are found errorless at the receiving party 4001, the receiving party 4001 will transmit ARQ feedback, for example, ACK (#1, Frag#1) 5012, ACK (#1, Frag#2) 5013. The errorless new sub-packets 513, 516 can be used to replace the erroneous parts of the packet 501 so as to restore the packet 501.

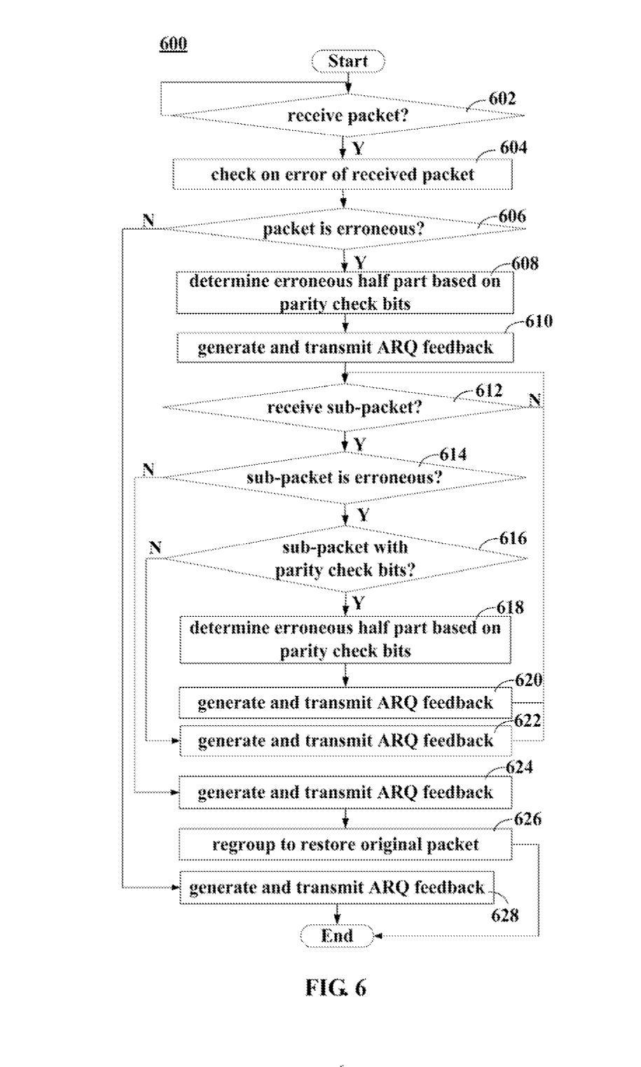

Referring to FIG. 6, a flowchart of an exemplary embodiment of a re-transmission control method 600 performed by a receiving party is illustrated. The example method 600 is provided by way of example, as there are a variety of ways to carry out the method. The method 600 described below can be carried out using the configurations illustrated in FIG. 1, and various elements of the figure is referenced in explaining example method 600. Each block shown in FIG. 6 represents one or more processes, methods or subroutines, carried out in the exemplary method 600. Furthermore, the illustrated order of blocks is by example only and the order of the blocks can change according to the present disclosure. Additional blocks may be added or fewer blocks may be utilized, without departing from this disclosure. The exemplary method 600 can be executed by a transmitting party, and can begin at block 602.

At block 602, the receiving party determines whether a packet is received. If a packet is received, the process goes to block 604, otherwise, the process goes back to block 602.

At block 604, the receiving party checks on an error of received packet. In the exemplary embodiment, any suitable method for checking errors in a packet can be employed, for example, check sum or Cyclic Redundancy Check (CRC).

At block 606, the receiving party determines whether the packet is erroneous. If the packet is erroneous, the process goes to block 608, otherwise, the process goes to block 628 in which the receiving party transmits an ARQ feedback to the transmitting party to inform the transmitting party that the packet is errorless.

At block 608, the receiving party determines which half part of the packet is erroneous based on the parity check bits of the packet. If a number of “1” in an half part of the packet is not corresponding to the parity check bit, the half part can be determined to be erroneous. For example, in FIG. 3, if the number of “1” in the first half part is “2”, while the corresponding parity check bit is “1”, the first half part will be determined to be erroneous.

At block 610, the receiving party generates an ARQ feedback and transmits the ARQ feedback to the transmitting party. The ARQ feedback can indicate that which half part of the packet has an error, for example, NACK (#1, Frag #1) 4011.

At block 612, the receiving party determines whether a sub-packet is received. If a sub-packet is received, the process goes to block 614, otherwise, the process goes back to block 612.

At block 614, the receiving party determines whether the sub-packet is erroneous. In the exemplary embodiment, the receiving party determines whether the sub-packet is erroneous using a same method with in block 604 and 606, for example, check sum or Cyclic Redundancy Check (CRC). If the sub-packet is found erroneous, the process goes to block 616, otherwise the process goes to block 624.

At block 616, the receiving party determines whether the sub-packet has parity check bits. If the sub-packet has parity check bits, the process goes to block 618, otherwise, the process goes to block 622.

At block 618, the receiving party determines which half part of the sub-packet is erroneous based on the parity check bits. If the parity check bit is “0”, a number of “1” in the corresponding half part should be even; while if the parity check bit is “1”, a number of “1” in the corresponding half part should be odd. That is, if the parity check bit is “0”, and the number of “1” in the corresponding half part is odd, the corresponding half part is determined erroneous; if the parity check bit is “1”, and the number of “1” in the corresponding half part is even, the corresponding half part is determined erroneous.

At block 620, the receiving party generates an ARQ feedback indicating the erroneous half part of the sub-packet, for example, NACK(#1, Frag#1) 4011 as illustrated in FIG. 4, and then transmits the ARQ feedback to the transmitting party.

At block 622, the receiving party generates an ARQ feedback indicating the sub-packet is erroneous, for example, NACK(#1, Frag#1), and transmitting the ARQ feedback to the transmitting party.

At block 624, the receiving party generates an ARQ feedback indicating the sub-packet is errorless, for example, ACK(#1, Frag#1), and transmitting the ARQ feedback to the transmitting party.

At block 626, the receiving party replaces the erroneous half part with the sub-packet to restore the packet as illustrated in FIG. 4.

At block 628, the receiving party generates an ARQ feedback indicating the packet is errorless, for example, ACK(#1), and transmitting the ARQ feedback to the transmitting party.

The method shown in FIG. 2 and FIG. 6 only illustrate transmission of a packet. However, in at least one exemplary embodiment, two or more packets can be transmitted from the transmitting party to the receiving party. In at least one exemplary embodiment, the two or more packets can be transmitted from the transmitting party to the receiving party using method illustrated in FIG. 7, FIG. 8 or FIG. 9. However, when one of the two or more packets is found erroneous at the receiving party, the packet can be re-transmitted and restored using the method illustrated in FIG. 2 and FIG. 6.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A re-transmission method, comprising:
generating, at a transmitting party, a packet;
adding, at the transmitting party, parity check bits to the packet to form a new packet;
transmitting, at the transmitting party, the new packet to a receiving party;
determining, at the transmitting party, whether an Automatic Repeat request (ARQ) feedback is received, wherein the ARQ feedback indicates which half part of the packet is found erroneous at the receiving party when the packet is found erroneous at the receiving party;
determining, at the transmitting party, which half part of the packet is found erroneous based on the ARQ feedback; and
re-transmitting, at the transmitting party, the half part of the packet which is found erroneous.

2. The method according to claim 1, further comprising:
determining, at the transmitting party, whether the half part that is found erroneous can be fragmented into two half parts based on an length of the half part;
generating, at the transmitting party, a sub-packet corresponding to the half part which is found erroneous;
adding, at the transmitting party, parity check bits to the sub-packet to be a new sub-packet if the half part can be fragmented into two half parts; and
re-transmitting, at the transmitting party, the new sub-packet.

3. The method according to claim 2, further comprising:
generating, at the transmitting party, a sub-packet corresponding to the half part which is found erroneous if the half part which is found erroneous cannot be fragmented; and
re-transmitting, at the transmitting party, the sub-packet.

4. The method according to claim 3, further comprising:
determining, at the transmitting party, whether an ARQ feedback related to the sub-packet is received;
determining, at the transmitting party, whether the sub-packet is found erroneous at the receiving party if the ARQ feedback related to the sub-packet is received; and
re-transmitting, at the transmitting party, the sub-packet if the sub-packet is found erroneous.

5. The method according to claim 2, further comprising:
determining, at the transmitting party, whether an ARQ feedback related to the new sub-packet is received;
determining, at the transmitting party, whether the new sub-packet is found erroneous at the receiving party if the ARQ feedback related to the sub-packet is received;
determining, at the transmitting party, which half part of the new sub-packet is found erroneous at the receiving party based on the ARQ feedback related to the new sub-packet; and
re-transmitting, at the transmitting party, the half part of the new sub-packet that is found erroneous at the receiving party.

6. The method according to claim 1, further comprising:
determining, at the transmitting party, whether the half part of the new sub-packet that is found erroneous can be fragmented into two half parts based on an length of the half part of the new sub-packet;
generating, at the transmitting party, a second sub-packet corresponding to the half part of the new sub-packet which is found erroneous;
adding, at the transmitting party, parity check bits to the second sub-packet to be a second new sub-packet if the half part of the new sub-packet can be fragmented into two half parts; and
re-transmitting, at the transmitting party, the second new sub-packet.

7. A re-transmission method, comprising:
determining, at a receiving party, whether a packet is received;
checking, at the receiving party, an error of the received packet;
determining, at the receiving party, whether the packet is erroneous;
determining, at the receiving party, which half part of the packet is erroneous if the packet is erroneous;
generating, at the receiving party, an Automatic Repeat request (ARQ) feedback indicating which half part of the packet is erroneous; and
transmitting, at the receiving party, the ARQ feedback to a transmitting party.

8. The method according to claim 7, further comprising:
determining, at the receiving party, whether a sub-packet is received;
determining, at the receiving party, whether the sub-packet is erroneous if the sub-packet is received;
determining, at the receiving party, whether the sub-packet has parity check bits if the sub-packet is erroneous;
determining, at the receiving party, which half part of the sub-packet is erroneous based on the parity check bits if the sub-packet has parity check bits;
generating, at the receiving party, an ARQ feedback indicating which half part of the sub-packet is erroneous; and
transmitting, at the receiving party, the ARQ feedback.

9. The method according to claim 8, further comprising:
generating, at the receiving party, an ARQ feedback indicating that the sub-packet is errorless if the sub-packet is errorless;
transmitting, at the receiving party, the ARQ feedback indicating that the sub-packet is errorless to the transmitting party; and
restoring, at the receiving party, the packet using the errorless sub-packet.

10. The method according to claim 7, further comprising:
generating, at the receiving party, an ARQ feedback indicating that the packet is errorless if the packet is errorless; and
transmitting, at the receiving party, the ARQ feedback indicating that the packet is errorless to the transmitting party.

11. The method according to claim 7, wherein determining whether the packet is erroneous using check sum or Cyclic Redundancy Check.

12. A transmitting party, comprising:
a packet generator configured to generate a packet;
a sub-packet generator configured to packet an half part of the packet to be a sub-packet;
an ARQ controller configured to control transmission of the packet or the sub-packet;
a transmitter configured to transmit the packet to a receiving party; and
a receiver configured to receive an ARQ feedback related to the packet or to the sub-packet from the receiving party.

13. The transmitting party according to claim 12, further comprising a storage device configured to store data that to be packaged into at least one packet.

14. The transmitting party according to claim 12, wherein the ARQ controller is configured to add two parity check bits to a packet to be a new packet, each parity check bit corresponding to a half part of the packet.

15. The transmitting party according to claim 12, wherein the ARQ controller is configured to control the sub-packet generator to package an half part of the packet to be a sub-packet if the half part is found erroneous at the receiving party.

16. The transmitting party according to claim 12, wherein ARQ controller is configured to:
determine whether the half part of the packet can be fragmented into two half part based on a length of the half part of the packet if the half part of the packet is found erroneous at the receiving party;
package the half part of the packet to be a sub-packet;
add parity check bits to the sub-packet to be a new sub-packet; and
transmit the new sub-packet to the receiving party.

17. The transmitting party according to claim 16, wherein ARQ controller is configured to:
determine whether the new sub-packet is found erroneous at the receiving party if the ARQ feedback related to the new sub-packet is received;
determine which half part of the new sub-packet is found erroneous at the receiving party based on the ARQ feedback related to the new sub-packet; and
re-transmit the half part of the new sub-packet that is found erroneous at the receiving party.
